(19) United States
(12) Patent Application Publication
(10) Pub. No.: US 2026/0002060 A1
(43) Pub. Date: Jan. 1, 2026

(54) TWO-COMPONENT THERMALLY-CONDUCTIVE STRUCTURAL ADHESIVE

(71) Applicant: DDP SPECIALTY ELECTRONIC MATERIALS US, LLC, Wilmington, DE (US)

(72) Inventors: Felix KOCH, Freienbach (CH); Beda STEINER, Freienbach (CH)

(21) Appl. No.: 18/839,285

(22) PCT Filed: Mar. 21, 2023
(86) PCT No.: PCT/US2023/015709

§ 371 Date: Aug. 16, 2024

Related U.S. Application Data
(60) Provisional application No. 63/322,281, filed on Mar. 22, 2022.

(51) Int. Cl. C09J 163/00; C09J 9/00; C09J 11/06; C09J 11/08

(52) U.S. Cl. CPC C09J 163/00; C09J 9/00; C09J 11/06; C09J 11/08; C09J 2400/20; C09J 2475/00

(57) ABSTRACT

Provided herein is a two-component thermally-conductive epoxy adhesive.

### CROSS-REFERENCE TO RELATED APPLICATIONS

This application claims priority to U.S. Provisional Patent Application No. 63/322,281, filed Mar. 22, 2022, which is incorporated into this application by reference.

### BACKGROUND

Currently there is a strong trend towards building electric driven vehicles to reduce fleet CO₂ emissions. The combination of a growing automotive market and a growing market share of electrically driven vehicles leads to a strong growth of the number of electrically driven vehicles.

To provide long driving ranges batteries with a high energy density are needed. Several battery strategies are currently followed with differing detailed concepts, but all long range battery concepts have in common that management of heat generated during use of batteries is needed. Thermally conductive adhesives are used to thermally connect and fix in place battery cells or modules to the cooling unit. The battery cells produce heat during charging and discharging operations. The cells need to be kept in the right operating temperature (preferably 25-40° C.) not to lose efficiency, and to avoid overheating which can result in a dangerous thermal runaway reaction. For these reasons, active cooling is used. Usually cooled water-glycol mixtures are pumped through channels that cool the metal bottom plate on which the battery cells/modules are placed. In order to connect the cell modules with the cooling plate, a thermally conductive adhesive is applied to bond it to the cooling plate. For efficiency of cooling, thermal conductivities of ≥1 W/mK are needed. To bond the battery modules to the cooling plate, high lap shear strength levels of more than 3 MPa are typically needed, more preferably more than 5 MPa, most preferably more than 7 MPa.

The cooling plates and module housings are most often designed using aluminum with no additional e-coat protection. The aluminum is typically passivated by a treatment such as for example by Ti/Zr coating which results in excellent corrosion protection. Also steel as a substrate is used in batteries by selected customers, which can be e-coated in corrosion prone areas or uncoated in dry areas. On such substrates polyurethane adhesives typically have challenges to build strong, durable bonds with excellent failure mode. Best adhesion to metals can typically be achieved by the application of epoxy adhesives.

For simplest application and best mixing quality typically, adhesives with 1:1 mixing ratios are desired by the end user for automated application. This is due to multiple reasons, including among others
the lowest impact of dosing errors,
with same size of doser as well as packaging (drum) of the adhesive in a 1:1 ratio, refill times of the doser as well as of the drum will occur at the same time, reducing down times.

Two component epoxy adhesives are typically prepared by the combination of one epoxy and one amine component. The typically used bisphenol A diglycidyl ether epoxy resin (DGBPA) has an epoxy equivalent weight of typically between 170 to 190 g/mol epoxy, while the typically used amines such as for example the often used 4,7,10-Trioxatridecane-1,13-diamine with a molecular weight of 220 g/mol and two primary amines results an active NH equivalent weight (NHEW) of as low as 55 g/mol or a molecule such as triethylenetetramine actually even an NHEW of only 22 g/mol. To design even balanced epoxy adhesives with an epoxy:NH ratio of around 1:1, typically higher amounts of very long polyether amines (often known as Jeffamines) are used. These are commercially available as a diamine with molecular weight up to 2000 g/mol (NH equivalent weight=500 g/mol). This enables the formulation of adhesives with a 2:1 or even a 1:1 mixing ratio. The use of such high molecular weight polyetheramines is not entirely desirable, since they negatively affect the glass transition temperature and the strength performance, especially at elevated temperatures. In addition, good electrical properties of the epoxy adhesive originate from the specific properties of the epoxy resin within the adhesive. So the higher the epoxy resin content in the finally cured matrix, the better the electrical properties. This is important since, for some applications, a volume resistivity of at least 1.0×10¹⁴ Ohm/cm is required.

For most thermally conductive adhesives, in order to achieve a thermal conductivity of ≥ 1 W/mK, a very high filler loading of around 70 wt % is needed when using aluminum hydroxide ATH. The adhesives are typically designed with a symmetric level of inorganic fillers in both the epoxy and the amine components to achieve a comparable rheology of both components.

### SUMMARY

In a first aspect, provided is a two-component, thermally conductive adhesive comprising:
(A) a Part A resin component, comprising:
(a1) at least one epoxy resin;
(a2) at least one reactive flexibilizer;
(a3) at least one reactive silane;
(a4) at least one thermally-conductive filler at a concentration of [a4] (wt %), based on the total weight of Part A;
and
(B) a Part B hardener component, comprising:
(b1) at least one polyamine;
(b2) at least one catalyst capable of catalyzing the reaction of an amine with an epoxy group;
(b3) at least one thermally-conductive filler at a concentration of [b3] (wt %), based on the total weight of Part B;
wherein, in use, Part A and Part B are mixed together in a volumetric ratio of 0.8:1 to 1.2:1 to form an adhesive mixture, and the concentration of thermally conductive filler in the adhesive mixture is from 65-85 wt %, based on the total weight of the adhesive mixture, and the ratio of [a4]:[b3] is from 0.7 to 0.9.

In a second aspect, provided is a method for producing an adhesive, comprising the steps:
(1) providing a Part A resin component, comprising:
   (a1) at least one epoxy resin;
   (a2) at least one reactive based flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9.

In a third aspect, provided is a method for adhering two substrates, the method comprising the steps:
(1) providing a Part A resin component, comprising:
   (a1) at least one epoxy resin;
   (a2) at least one reactive flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9;
(4) applying the adhesive mixture to at least one substrate;
(5) bringing a second substrate into adhesive contact with the adhesive mixture; and
(6) allowing the adhesive mixture to cure.

### DETAILED DESCRIPTION

The inventors have surprisingly found that the epoxy component (A-component) and the amine component (B-component) of a two-component epoxy adhesive can be filled with a significant deviation of filler volume content of more than 10% by weight difference between the two components. The filler content in Part A is reduced, for example, to 60-65% by weight which enables to increase the content of the organic epoxy resin matrix in Part A while the Part B filler load is increased to, for example, 75-80%. As a result, even though the full adhesive is a 1:1 mixing ratio by weight, the ratio of the organic compounds is very close to a 2:1 mixing ratio. The resulting adhesive has a very high strength and very good adhesion to a metal surface.

### DEFINITIONS AND ABBREVIATIONS

ATH aluminium trihydroxide
PTMEG poly(tetramethylene oxide) glycol
DGEBA bis-phenol A diglycidyl ether
polyTHF poly(tetramethylene oxide) glycol
PBD poly(butadiene)diol
DBTL dibutyl tin dilaurate
HDI hexamethylene diisocyanate
PTHF poly(tetrahydrofuran)
MDI Methylene diphenyl diisocyanate

Molecular weights of polymers as reported herein are reported in Daltons (Da) as number or weight average molecular weights, as determined by size exclusion chromatography (SEC). If not otherwise stated, it refers to number average molecular weight.

The two-component adhesive consists of a Part A (resin component), and a Part B (hardener component). In use, Part A and Part B are mixed in a desired ratio, and then applied to a substrate or substrates.

### Component A

### Component a Comprises:

(a1) at least one epoxy resin;
(a2) at least one reactive flexibilizer;
(a3) at least one reactive silane;
(a4) at least one thermally-conductive filler at a concentration of [a4] (wt %), based on the total weight of Part A;

Each of the ingredients will be discussed in turn.

### At Least One Epoxy Resin (a1)

Part A of the two-component adhesive contains at least one epoxy resin. Epoxy resins useful in adhesive compositions include a wide variety of curable epoxy compounds and combinations thereof. Useful epoxy resins include liquids, solids, and mixtures thereof, liquids being useful. Typically, the epoxy compounds are epoxy resins which are also referred to as monoepoxides or polyepoxides. Polyepoxides useful herein can be monomeric (e.g., the diglycidyl ether of bisphenol A, diglycidyl ether of bisphenol F, diglycidyl ether of tetrabromobisphenol A, novolac-based epoxy resins, and tris-functional epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2 epoxy group (i.e., vicinal epoxy group) per molecule. Solid epoxy resins that may be used can comprise or preferably be based upon mainly bisphenol A. Some epoxy resins include, for example, D.E.R. 330, D.E.R. 331, and D.E.R. 671, all commercially available from The Dow Chemical Company. Monoepoxides useful herein can be reactive diluents carrying only one 1,2-epoxy group such as for example para-tertbutylphenylglycidyl ether (Araldite DY-T), glycidyl ether of long chain aliphatic alcohols such as monoglycidylether of mixture of C12 and C14 alcohol (Araldite DY-E) or more 1,2-epoxy groups like for example the reaction product of epichlorohydrin and polypropylene glycol (DER 732).

One preferable epoxy resin has general formula:

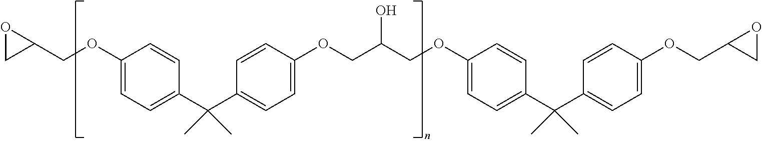

where n is in the range of 0 to about 25.

Exemplary epoxy resins have epoxy equivalent weights in the range of about 170 to 195 g/mol.

Combinations of epoxy resins may be used to adjust properties of the epoxy adhesive. In compositions and methods, the epoxy adhesive may comprise any amount of epoxy resin. Preferably, the liquid and/or solid epoxy resin comprise more than or about 20 wt %, more preferably more than or about 25 wt %, 30 wt % or 35 wt %, of the epoxy adhesive. Preferably, the liquid and/or solid epoxy resin comprise less than or about 65 wt %, more preferably less than or about 55 wt % or 45 wt %, of the epoxy adhesive.

Other amounts are shown in the Examples. Ranges formed from pairs of these values (e.g., 25 to 35 wt %, 25 to 65 wt %, 30 to 38 wt % (adhesive AA)) are also disclosed.

When a combination of liquid and solid epoxy resins is used, any proportion can be used, and can be determined by one of ordinary skill in the art. In order to obtain a suitable viscosity, it is generally useful that the weight proportion of liquid to solid epoxy resin is greater than 50:50. Epoxy adhesive compositions can comprise liquid and solid epoxy resins in a ratio of, or greater than, 55:45, 65:35, or 70:30. Epoxy adhesive compositions can comprise liquid and solid epoxy resins in a ratio of, or less than, 100:0, 99:1, 90:10, or 85:10. Other ratios are shown in the Examples. Ranges formed from pairs of these values (e.g. 50:50 to 100:0, 65:35 to 82:18 (adhesive AU)) are also disclosed.

### Preferred Epoxy Resins Include:

Epoxy 1. A liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445), for example, DER 331;
Epoxy 2. A solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), for example, DER 671;

### Particularly Preferred is Epoxy 1.

The epoxy resin can be present in the adhesives at 20 to 40 wt %, more preferably 25 to 35 wt %, particularly preferably at 26 to 34 wt %, based on the total weight of Part A of the adhesive.

In one embodiment, the epoxy resin is Epoxy 1, used at 26 to 29 wt %, based on the total weight of Part A of the adhesive.

In one embodiment, Part A has an epoxy equivalents per litre of from 1.50 to 4.50, more preferably 2.50 to 3.5, particularly preferably 3.00 to 3.30 mmol/l.

### Reactive Flexibilizer (a2)

Part A of the two-component adhesives comprises at least one reactive flexibilizer.

A reactive flexibilizer (sometimes referred to as a toughener) is an elastomeric molecule having end groups that are capable of reacting with epoxy resins or epoxy resin hardeners in the presence of a catalyst, or which can be cleaved to reveal an end group that is capable of reacting with epoxy resins or epoxy resin hardeners in the presence of a catalyst.

Preferred flexibilizers used in the inventive compositions are reactive polyurethane-based tougheners made by reacting at least one polyol and optionally poly(butadiene)diol with a polyisocyanate in the presence of a polyurethane catalyst, optionally followed by chain extension with a di-phenol, and end-capping with a phenol, an oxime or a molecule of Formula I:

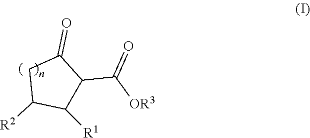

where R¹ and R² are independently selected from hydrogen and C₁ to C₆ alkyl, n is an integer from 1 to 2, and R³ is C₁ to C₆ alkyl.

In another preferred embodiment, the end or capping group is a phenol, particularly preferably a diphenol or a monophenol, particularly preferably O,O′-diallylbisphenol A or cardanol.

If the end group is a molecule of Formula I, preferably R¹ and R² are independently selected from H and C₁ to C₄ alkyl, more preferably H and C₁ to C₂ alkyl, particularly preferably R¹ and R² are H.

In a preferred embodiment, R³ is C₁ to C₄ alkyl, more preferably C₁ to C₂ alkyl.

In a preferred embodiment, n is 1.

In another preferred embodiment, R¹ and R² are H, R³ is ethyl or methyl, particularly ethyl, and n is 1. In a particularly preferred embodiment, the capping molecule is CPEE.

The at least one polyol is preferably a diol or triol or mixture of both. Diols are particularly preferred. In a preferred embodiment, the at least one polyol is a poly(alkylene oxide)diol. Preferred poly(alkylene oxide)diols are selected from poly(C₂-C₆ alkylene oxide)diols, particularly poly(tetramethylene oxide)diol (“PTMEG”), poly(trimethylene oxide)diol (“PO3G”), and mixtures of these. The poly(alkylene oxide)diol preferably has a molecular weight in the range of 1,000 to 2,500 Da, more preferably 1,000, to 2,000 Da. PTMEG is particularly preferred. Preferably, the PTMEG has a molecular weight in the range of 1,000 to 2,500 Da, more preferably 1,000 to 2,000 Da.

In a preferred embodiment PBD is included in the toughener backbone.

In another preferred embodiment, chain extension with a di-phenol is carried out.

In another preferred embodiment, PBD is included and chain extension with a di-phenol is carried out.

In another preferred embodiment, PBD is not included.

In another preferred embodiment, chain extension is not carried out.

In another preferred embodiment, PBD is not included and chain extension is not carried out.

If used, the PBD preferably has a molecular weight in the range of 1,000 to 3,500 Da, more preferably 2,800 Da.

The polyisocyanate is not particularly limited. It may be aromatic or aliphatic. Examples of suitable polyisocyanates include toluene diisocyanate, 1,6-hexamethylenediisocyanate (“HMDI” or “HDI”), methylene diphenyl diisocyanate (“MDI”), 2,2,4-trimethylhexamethlyendiisocyanate (TMDI) and isophorone diisocyanate (IPDI). HMDI is particularly preferred.

The polyurethane catalyst is not particularly limited. Dibutyltin dilaurate (“DBTL”) and metal carboxylates, such as bismuth and/or zinc carboxylates, are particularly preferred. The catalyst is preferably used at 0.01 to 0.5 wt %, more preferably 0.1 wt %, based on the total weight of the toughener. In a preferred embodiment, the catalyst is a mixture of bismuth and zinc carboxylates, used at 0.1 wt %, based on the total weight of the toughener.

Optional chain extension is carried out with a di-phenol. O,O′-diallylbisphenol A (“ODBA”) is particularly preferred. The di-phenol is preferably used at 2 to 10 wt %, more preferably 5 to 8 wt %, particularly preferably 7 wt %, based on the total weight of the toughener. Alternatively, the chain-extender may be used at a molar ratio to the polyol of from 0:1 to 1:1, more preferably 0:1 to 0.8:1, particularly preferably 0.6:1 to 0.8:1.

Reaction of the diol, polyisocyanate and diphenol chain extender (if used) are such that the molecule before capping is terminated with NCO groups. End-capping is then carried out with a phenol, diphenol or molecule of Formula I. if a molecule of Formula I is used as the end-capping group, a catalyst, such as, for example, at least one metal carboxylate, particularly zinc and/or bismuth carboxylates is used.

The toughener preferably contains 40 to 90 wt % polyol, in particular poly(alkylene oxide)diol, more preferably 45 to 85 wt %, more particularly preferably 50 to 85 wt %, based on the total weight of the toughener. Particularly preferably the toughener contains 40 to 90 wt % PTMEG, more preferably 45 to 85 wt %, more particularly preferably 50 to 85 wt %, based on the total weight of the toughener.

If present, PBD is preferably present in the toughener at 10 to 25 wt % PBD, more preferably 12 to 18 wt %, based on the total weight of the toughener, with PBD having a molecular weight of 2,800 Da being particularly preferred.

In a preferred embodiment, the toughener comprises toluene diisocyanate as the polyisocyanate, poly(propylene oxide)diol as the polyol and cardanol as the end-capping group.

In another preferred embodiment, the toughener comprises hexamethylene diisocyanate as the polyisocyanate, poly(tetramethylene oxide)diol as the polyol, and O,O′-diallylbisphenol A as chain extender and end-capping group.

A preferred method for making the toughener is the following process:

1. First reaction step: the polyol, preferably poly(alkylene oxide)diol (more preferably PTMEG) and PBD (if used) are heated to 120-130° C. The mixture is heated for 25-35 minutes under vacuum. The mixture is cooled to 50-70° C. When the temperature reaches 50-70° C. diisocyanate (preferably HDI) is added and the mixture is mixed for 2-5 minutes. The polyurethane catalyst is then added (for example, an organotin compound) and the mixture is allowed to react at 75-90° C. (bath temperature) for 40-50 minutes under a neutral atmosphere (e.g. nitrogen, argon).

2. Second reaction step: the chain extender (if used) is added and the mixture is stirred for 50-70 minutes at 85-95° C. (bath temperature) under a neutral atmosphere (e.g. nitrogen, argon).

3a. Third reaction step (if molecule of Formula I is used as end-group): the end-capping molecule of Formula I is added (for example, CPEE) and the mixture is stirred for 80-95 minutes at 85-95° C. (bath temperature) under a neutral atmosphere (e.g. nitrogen, argon). The mixture is stirred for 10 minutes at 95° C. under vacuum for degassing.

3b. Third reaction step (if diphenol or monophenol are used as end-group): the mono- or diphenol is added and the mixture is stirred for 80-95 minutes at 85-95° C. (bath temperature) under a neutral atmosphere (e.g. nitrogen, argon). The mixture is stirred for 10 minutes at 95° C. under vacuum for degassing.

The reactive flexibilizer is preferably present in Part A at 2-10 wt %, more preferably 3-8 wt %, particularly preferably 4-6 wt %, based on the total weight of Part A.

In a preferred embodiment, the reactive flexibilizer is a polyurethane-based flexibilizer and is present at 2-10 wt %, more preferably 3-8 wt %, particularly preferably 4-6 wt %, based on the total weight of Part A.

In another preferred embodiment, the reactive flexibilizer is made by reacting at least one polyol and optionally poly(butadiene) diol with a polyisocyanate in the presence of a polyurethane catalyst, optionally followed by chain extension with a di-phenol, and end-capping with a phenol, an oxime or a molecule of Formula I:

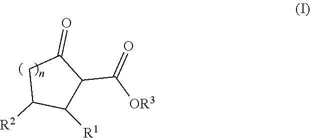

where R¹ and R² are independently selected from hydrogen and C₁ to C₆ alkyl, n is an integer from 1 to 2, and R³ is C₁ to C₆ alkyl, and is present at 2-10 wt %, more preferably 3-8 wt %, particularly preferably 4-6 wt %, based on the total weight of Part A.

### Reactive Silane (a3)

Component A comprises at least one reactive silane.

Reactive silanes are any silane that comprises a hydrolysable silyl alkoxy group covalently bonded to a mercapto group, a primary or secondary amine group, or an epoxy group.

In a preferred embodiment, the reactive silane is a mercapto silane. Preferably, the mercaptosilane is selected from mercaptoalkyl(trialkoxy)silanes and mercaptoalkyl(methyl-dialkoxy)silanes. Examples of suitable mercaptosilanes include gamma-mercaptopropyltrimethoxysilane, gamma-mercaptopropyl(methyl-dimethoxy)silane, with gamma-mercaptopropyltrimethoxysilane being particularly preferred.

In another preferred embodiment, the reactive silane is an aminosilane. Preferably, the aminosilane is selected from aminoalkyl(trialkoxy)silanes and aminoalkyl(methyl-dialkoxy)silanes. Examples of suitable aminosilanes include bis-(trimethoxysilylpropyl)amine, (3-aminopropyl)trimethoxysilane, (3-aminopropyl)triethoxysilane, N-(2-aminoethyl)-3-aminopropyltrimethoxysilane, trimethoxysilylpropyldiethylenetriamine, with bis-(trimethoxysilylpropyl)amine, (3-aminopropyl)trimethoxysilane being particularly preferred.

In another preferred embodiment, the reactive silane is an epoxy silane. Preferably, the epoxy silane is selected from glycidyloxyalkyl(trialkoxy)silanes and glycidyloxyalkyl(methyl-dialkoxy)silanes. Examples of suitable epoxy silanes include Tris(diethyleneglycolmethylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, 2-(3,4-Epoxycyclohexyl)-ethyltriethoxysilane, with Tris(diethyleneglycolmethylether) silyl propyleneglycidylether being particularly preferred.

The reactive silane is preferably present in Component A at 0.25-2.25 wt %, more preferably at 0.5 to 1.75 wt %, particularly preferably at 0.75 to 1.5 wt %, based on the total weight of Component A.

In a preferred embodiment, the reactive silane is selected from glycidyloxyalkyl(trialkoxy)silanes and glycidyloxyalkyl(methyl-dialkoxy)silanes and is present at 0.25-2.25 wt %, more preferably at 0.5 to 1.75 wt %, particularly preferably at 0.75 to 1.5 wt %, based on the total weight of Component A.

In a preferred embodiment, the reactive silane is Tris(diethyleneglycolmethylether) silyl propyleneglycidylether and is present at 0.25-2.25 wt %, more preferably at 0.5 to 1.75 wt %, particularly preferably at 0.75 to 1.5 wt %, based on the total weight of Component A.

### Thermally Conductive Filler (a4, b3)

The thermally conductive filler used as a4 and b3 is not particularly limited. Suitable thermally conductive fillers are those that have a coefficient of thermal conductivity that is greater than 5 W/m° K, greater than 10 W/m° K, or greater than 15 W/m° K. Examples of thermally conductive fillers include alumina, alumina trihydrate or aluminum trihydroxide, silicon carbide, boron nitride, diamond, and graphite, or mixtures thereof.

Particularly preferred are aluminium trihydroxide (ATH), and aluminium oxide, with ATH being the most preferred.

In a preferred embodiment, the thermally conductive filler has a broad particle size distribution characterized by a ratio of D90/D50 of at or about 3 or more. Particularly preferably the thermally conductive filler is ATH or aluminium oxide having a broad particle size distribution characterized by a ratio of D90/D50 of at or about 3 or more, most preferably ATH.

Also preferred are thermally conductive fillers having a bimodal particle size distribution. A bimodal distribution is when, for example, the ratio D₉₀/D₅₀ is at or about 3 or more, more preferably at or about 5 or more, more particularly preferably at or about 9 or more. For example, particles having a D₅₀ of 5 to 20 microns and a D₉₀ of 70 to 90 microns, particularly a D₅₀ of 7-9 microns and a D₉₀ of 78-82 microns. Particle size can be determined using laser diffraction. For ATH a suitable solvent is deionized water containing a dispersion aid, such as Na₄P₂O₇×10 H₂O, preferably at 1 g/l. Preferred are aluminium oxide and ATH having a bimodal distribution, particularly ATH.

The thermally conductive filler is present in the final adhesive at a concentration of 65-85 wt %, based on the total weight of the adhesive. It is preferably present in the final adhesive at a concentration that gives a thermal conductivity of at or about 1.1 W/mK or more.

The thermally conductive filler is present in both Parts A (a4) and B (b3), and the ratio of [a4]:[b3] is from 0.7 to 0.9. In a preferred embodiment, the ratio of [a4]:[b3] is from 0.72 to 0.87, 0.7 to 0.8, or more preferably between 0.73 to 0.87.

In a preferred embodiment, the thermally conductive filler is used at a concentration of 50-80 wt %, more preferably 55-65 wt % in Part (A), based on the total weight of Part A.

In another preferred embodiment, the thermally conductive filler is used at 70-90 wt %, more preferably 75 to 85 wt % in Part (B), based on the total weight of Part (B).

In another preferred embodiment, the thermally conductive filler is ATH, and is used at a concentration of 50-80 wt %, more preferably 55-65 wt % in Part (A), based on the total weight of Part A.

In another preferred embodiment, the thermally conductive filler is ATH, and is used at 70-90 wt %, more preferably 75 to 85 wt % in Part (B), based on the total weight of Part (B).

In a preferred embodiment, the thermally conductive filler is used at a concentration of 50-80 wt %, more preferably 55-65 wt % in Part (A), based on the total weight of Part A, and 70-90 wt %, more preferably 75 to 85 wt % in Part (B), based on the total weight of Part (B). In a particularly preferred embodiment, the thermally conductive filler is used at 60 wt % in part A, based on the total weight of Part A, and 80 wt % in part B, based on the total weight of Part B.

In a particularly preferred embodiment, the thermally conductive filler is ATH having a ratio D₉₀/D₅₀ of at or about 8 or more, used at a concentration of 50-80 wt %, more preferably 55-65 wt % in Part (A), based on the total weight of Part A

In another preferred embodiment, the thermally conductive filler is ATH having a ratio D₉₀/D₅₀ of at or about 8 or more, and is used at 70-90 wt %, more preferably 75 to 85 wt % in Part (B), based on the total weight of Part (B).

In a particularly preferred embodiment, the thermally conductive filler is ATH having a ratio D₉₀/D₅₀ of at or about 8 or more, and is used at 60 wt % in part A, based on the total weight of Part A, and 80 wt % in part B, based on the total weight of Part B.

In a particularly preferred embodiment, the thermally conductive filler is ATH having a ratio D₉₀/D₅₀ of at or about 8 or more, used at a concentration of 50-80 wt %, more preferably 55-65 wt % in Part (A), based on the total weight of Part A, and 70-90 wt %, more preferably 75 to 85 wt % in Part (B), based on the total weight of Part (B). In a particularly preferred embodiment, the thermally conductive filler is ATH having a ratio D₉₀/D₅₀ of at or about 8 or more, and is used at 60 wt % in part A, based on the total weight of Part A, and 80 wt % in part B, based on the total weight of Part B.

### Other Ingredients of Component A

Component A may comprise additional optional ingredients, such as, for example:

Additional impact modifiers, such as, for example:
Rubber modifiers such as adducts formed from the reaction of an epoxy resin and carboxy terminated butadiene acrylonitrile rubber, preferably at 0-30 wt %, based on the total weight of Part A
Silicone tougheners, preferably at 0-30 w %, based on the total weight of Part A
Core-shell rubber toughener, preferably at 0-30 w %, based on the total weight of Part A

Phosphoric acid modified epoxy resins, preferably at 0-15 wt %, based on the total weight of Part A.

One or more silane adhesion promoters, for example tris(diethylene glycol methylether) silyl propyleneglycidylether.

Monofunctional, difunctional and trifunctional epoxy-reactive diluents, such as, for example, di-phenols, monophenols, for example cardanol, monoglycidyl ethers of C₁₂-14-alcohols, (trimethylolpropane triglycidylether) resins, and diglycidyl ether of cyclohexane dimethanol.

Plasticizers, such as phthalates and dialkyl naphthalenes, in particular dialkyl phthalates, for example di-iso-nonyl phthalate and dialkyl naphthalenes, such as di-iso-propyl naphthalene.

Reinforcing agents, and fillers, such as glass (fibre, flakes, microspheres), carbon fibre, graphite, carbon black, wollastonites (in particular, high aspect ratio wollastonites), calcium carbonate, TiO₂, fumed silica, and mixtures of any of these. Reinforcing agent and/or filler is preferably used at 0-15 wt %, based on the total weight of Part A excluding thermally conductive filler described above.

Flame-retardants and synergists, such as phosphorus- and nitrogen-based flame-retardants. Examples include melamine polyphosphate, melamine pyrophosphate, melamine cyanurate, dialkyl aluminium phosphinates, such as diethyl aluminium phosphinate. If used, flame-retardants and synergists are present at 0 to 10 wt %, based on the total weight of Component A.

### Component B

### Component B Comprises:

(b1) at least one polyamine;
(b2) at least one catalyst capable of catalyzing the reaction of an amine with an epoxy group;
(b3) at least one thermally-conductive filler at a concentration of [b3] (wt %), based on the total weight of Part B;

Each of the ingredients will be discussed in turn.

### At Least One Polyamine (b1)

Component B comprises at least one polyamine that is capable of cross-linking with epoxy groups on the epoxy resin. Polyamines include molecules with two or more amine groups.

Preferred polyamines include secondary amines and primary amines, in particular polymeric amines, low molecular weight amines, and combinations thereof.

In a preferred embodiment, the polyamine includes a polyetheramine, that is, molecules having a polyether backbone with terminal amine groups. Also preferred are reaction products of a stoichiometric excess of an amine prepolymer with an epoxy resin. The amine prepolymer may be any amine prepolymer that has at least two amine groups in order to allow cross-linking to take place. The amine prepolymer comprises primary and/or secondary amine groups, and preferably comprises primary amine groups. Suitable amine prepolymers include polyether diamines and polyether triamines, and mixtures thereof.

The polyetheramines may be linear, branched, or a mixture. Branched polyether amines are preferred. Any molecular weight polyetheramine may be used, with molecular weights in the range of 200-6000 or above being suitable. Molecular weights may be above 1000, or more preferably above 3000. Molecular weights of 3000 or 5000 are preferred.

Examples of suitable commercially available polyamines include:

TABLE B
Examples of polyamines that can be used in Component B

| Trade name | Nature |
|---|---|
| Jeffamine T-403 | Polyetheramine characterized by repeating oxypropylene units in the backbone. JEFFAMINE T-403 is a trifunctional primary amine having an average molecular weight of approximately 440. Its amine groups are located on secondary carbon atoms at the ends of aliphatic polyether chains. 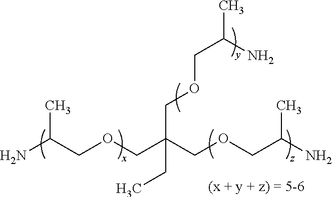 |
| Jeffamine D-400 | Polyoxypropylenediamine: an Amine-terminated polyoxypropylene diol 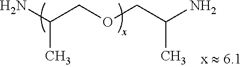 |
| Jeffamine D-2000 | Polyetheramine characterized by repeating oxypropylene units in the backbone. JEFFAMINE D- 2000 polyetheramine is a difunctional, primary amine with average molecular weight of about 2000. The primary amine groups are located on secondary carbon atoms at the end of the aliphatic polyether chains. 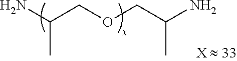 |
| TETA | Triethylenetetramine |
| Lupasol P | A branched aqueous solution of high molecular weight polyethylenimine homopolymer. 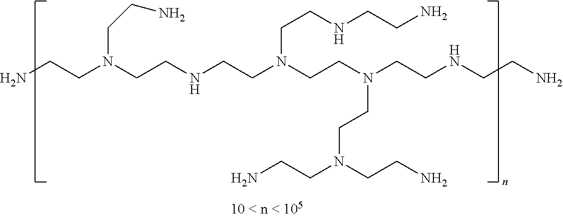 |
| 4,7,10-Trioxatridecane-1,13- diamine | 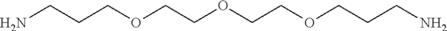 [SMILES: NCCCOCCOCCOCCCN] |
| | Mixtures of any of the above |

In a preferred embodiment, the polyamine of Component B comprises a mixture of TETA and a difunctional, primary amine with average molecular weight of about 2000, of the following general structure:

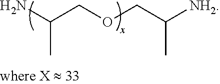

The concentration of polyamine in Component B will depend on the degree of cure that is desired in the cured adhesive, and also on the mixing ratio of Component A and Component B that is desired. In one preferred embodiment, in which the mixing ratio (volume) of Component A to Component B is from 0.8:1 to 1.2:1, in particular 1:1, the NH equivalents per liter of Component B is in the range of 1.5 to 4.50 mol/l, more preferably in the range of 2.50 to 3.75 mol/l, particularly preferably 3.00-3.40 mol/l.

In a preferred embodiment, the total amine content in Component B is from 5 to 18 wt %, more preferably 7 to 15 wt %, particularly preferably 9 to 13 wt %, based on the total weight of Component B.

Catalyst Capable of Catalyzing the Reaction of an Amine with an Epoxy Group (b2)

Component B contains a catalyst capable of catalyzing the reaction of an amine with an epoxy group. Suitable catalyst may be a Lewis acid or a Lewis base.

Examples of suitable catalysts are ureas and/or tertiary amines, For example, p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl) phenol, piperidine or derivatives thereof, various aliphatic urea compounds such as are described in EP1916272; C₁-C₁₂ alkylene imidazole or N-arylimidazoles, such as 2-ethyl-2-methylimidazol, or N-butylimidazole and 6-caprolactam, 2,4,6-tris(dimethylaminomethyl) phenol, particularly integrated into a poly(p-vinylphenol) matrix (as described in European patent EP0197892), or 2,4,6-tris(dimethylaminomethyl) phenol integrated into a novolac resin, including those described in U.S. Pat. No. 4,701,378, are suitable. Particularly preferred are tertiary amines, in particular tris-2,4,6-tris(dimethylaminomethyl) phenol.

The catalyst is preferably used at 0.1 to 6 wt %, more preferably 2 to 5 wt %, particularly preferably 3 or 4 wt %, based on the total weight of Component B.

In a preferred embodiment, the epoxy curing catalyst is 2,4,6-tris(dimethylaminomethyl) phenol used at 2 to 5 wt %, based on the total weight of Component B.

### Other Ingredients of Component B

Component B may comprise additional optional ingredients, such as, for example:

One or more silane adhesion promoters, for example N-(n-Butyl)-3-aminopropyltrimethoxysilane.

Plasticizers, such as phthalates and dialkyl naphthalenes, in particular dialkyl phthalates, for example di-iso-nonyl phthalate and dialkyl naphthalenes, such as di-iso-propyl naphthalene.

Reinforcing agents, and fillers, such as glass (fibre, flakes, microspheres), carbon fibre, graphite, carbon black, wollastonites (in particular, high aspect ratio wollastonites), calcium carbonate, TiO₂, fumed silica, and mixtures of any of these. Reinforcing agent and/or filler is preferably used at 0-15 wt %, more preferably 0-10 wt %, based on the total weight of Part B.

Curing accelerators, such as p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl) phenol, piperidine or derivatives thereof, various aliphatic urea compounds such as are described in EP1916272; C₁-C₁₂ alkylene imidazole or N-arylimidazoles, such as 2-ethyl-2-methylimidazol, or N-butylimidazole and 6-caprolactam, 2,4,6-tris(dimethylaminomethyl) phenol, particularly integrated into a poly(p-vinylphenol) matrix (as described in European patent EP0197892), or 2,4,6-tris(dimethylaminomethyl) phenol integrated into a novolac resin, including those described in U.S. Pat. No. 4,701,378, are suitable. Particularly preferred are tertiary amines, in particular tris-2,4,6-tris(dimethylaminomethyl) phenol. If used, the curing accelerator is preferably present at 0 to 10 wt %, based on the total weight of Component B.

Flame-retardants and synergists, such as phosphorus- and nitrogen-based flame-retardants. Examples include melamine polyphosphate, melamine pyrophosphate, melamine cyanurate, dialkyl aluminium phosphinates, such as diethyl aluminium phosphinate. If used, flame-retardants and synergists are present at 0 to 10 wt %, based on the total weight of Component B.

### Cured Adhesive

In one aspect, provided is a cured adhesive resulting from mixing Components A and B described herein, and allowing the resulting mixture to cure.

Components A and B can be mixed by any method that provides a homogeneous mixture relatively rapidly. In a preferred embodiment, mixing is achieved using a static mixer at the time of dispensing Component and Component B, through nozzles.

The mixing ratio of Component A and Component B, A:B is 0.8:1 to 1.2:1, more preferably 1:1.

### Method for Producing an Adhesive

In another aspect, provided is a method for producing an adhesive, comprising the steps:
(1) providing a Part A resin component, comprising:
   (a1) at least one epoxy resin;
   (a2) at least one reactive flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9.

The preferred embodiments described herein for the adhesive apply equally to the method for making the adhesive.

Mixing in step (3) can be carried out by any method that provides a homogeneous mixture relatively rapidly. In a preferred embodiment, mixing is achieved using a static mixer at the time of dispensing Component and Component B, through nozzles.

In a preferred embodiment, the epoxy equivalents per litre of Part A and the NH equivalents per liter of Part B is within the range of 0.8:1 to 1.2:1.

In an embodiment, the volumetric ratio in step (3) is 1:1.

In another embodiment, the ratio of [a4]:[b3] is 0.60 to 0.90.

In an embodiment of the method, the volumetric ratio in step (3) is 1:1, and the ratio of [a4]:[b3] is 0.65 to 0.85.

In an embodiment of the method, the volumetric ratio in step (3) is 1:1, the ratio of [a4]:[b3] is 0.65 to 0.85 and the ratio of epoxy equivalents of Part A and the NH equivalents of Part B is within the range of 0.8:1 to 1.2:1.

### Method for Adhering Two Substrates

In another aspect, provided is a method for adhering two substrates, the method comprising the steps:
(1) providing a Part A resin component, comprising:
   (a1) at least one epoxy resin;
   (a2) at least one reactive flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9;
(4) applying the adhesive mixture to at least one substrate;
(5) bringing a second substrate into adhesive contact with the adhesive mixture; and
(6) allowing the adhesive mixture to cure.

The preferred embodiments described herein for the adhesive apply equally to the method for adhering substrates.

The adhesives are particularly suited for adhering metal to metal, in particular steel, aluminium, magnesium, titanium, nickel-plated steel, stainless steel, coated steels typically used in the automotive industry, such as zinc coated steels, and zinc magnesium coated steels, metal surfaces coated with an organic coating such as epoxy powder coat, PET foil, plastic surfaces.

In a preferred embodiment, the first and second substrate are both metal, in particular steel or aluminum.

Curing is carried out by simply allowing the mixture to sit, preferably at room temperature. A functionally-useful cure is typically attained after 7 days at room temperature. An acceleration of cure can be achieved by heat. A functionally-useful cure can also be achieved after 2 h 60° C.

### Effect of the Disclosed Adhesives

The cured (7 days, RT) adhesive preferably has a thermal conductivity of greater than or equal to 1.0 W/Km, more preferably greater than or equal to 1.1 W/km, when measured according to ASTM 5470-12, according to the Examples described herein.

The cured (7 days, RT) adhesive preferably has an E-modulus of 1.00 MPa or greater, more preferably 1000 MPa or greater, particularly preferably 4,000 MPa or greater, when measured according to DIN ISO EN-527-1:2012-06, as described in the Examples herein.

The cured (7 days, RT) adhesive preferably has a lap shear strength of 12 MPa or greater, when measured on DX 56 Z 0.7 mm steel, as described in the Examples herein.

The cured (7 days, RT) adhesive preferably has a T-peel strength at 23° C. of 1.1 N/mm or greater, when measured on DX 56 Z 0.7 mm steel, according to ISO 11339:2010.

The cured (7 days, RT) adhesive preferably has a T-peel failure mode at 23° C. of at least 80% cohesive failure, more preferably at least 90% cohesive failure, more particularly preferably at least 95% cohesive failure, when measured on DX 56 Z 0.7 mm steel, as described in the Examples herein.

The cured (7 days, RT) adhesive preferably has a volume resistivity of at least 10Ω−m, when measured as described in the Examples herein.

In a particularly preferred embodiment, the cured (7 days, RT) adhesive has a thermal conductivity of greater than or equal to 1.0 W/Km, more preferably greater than or equal to 1.1 W/km, when measured according to ASTM 5470-12, according to the Examples described herein, and an E-modulus of 100 MPa or greater, more preferably 1000 MPa or greater, particularly preferably 4,000 MPa or greater, when measured according to DIN ISO EN-527-1:2012-06, as described in the Examples herein, and a lap shear strength of 12 MPa or greater, when measured on DX 56 Z 0.7 mm steel, as described in the Examples herein, and a T-peel strength at 23° C. of 1.1 N/mm or greater, when measured on DX 56 Z 0.7 mm steel, according to ISO 11339:2010, and a T-peel failure mode at 23° C. of at least 80% cohesive failure, more preferably at least 90% cohesive failure, more particularly preferably at least 95% cohesive failure, when measured on DX 56 Z 0.7 mm steel, as described in the Examples herein, and a volume resistivity of at least 10Ω−m, when measured as described in the Examples herein.

### Applications

The adhesives are particularly suited to adhering components of battery assemblies, in particular in electric vehicles, where thermal conductivity and good structural properties are required. Particular examples include bonding of battery cells to a module plate or cooling plate, battery modules to a cooling plate or similar.

### Examples of Specific Embodiments

1. A two-component, thermally conductive adhesive comprising:
(A) a Part A resin component, comprising:
(a1) at least one epoxy resin;
(a2) at least one reactive flexibilizer;
(a3) at least one reactive silane;
(a4) at least one thermally-conductive filler at a concentration of [a4] (wt %), based on the total weight of Part A;
and
(B) a Part B hardener component, comprising:
(b1) at least one polyamine;
(b2) at least one catalyst capable of catalyzing the reaction of an amine with an epoxy group;
(b3) at least one thermally-conductive filler at a concentration of [b3] (wt %), based on the total weight of Part B;
wherein, in use, Part A and Part B are mixed together in a volumetric ratio of 0.8:1 to 1.2:1 to form an adhesive mixture, and the concentration of thermally conductive filler in the adhesive mixture is from 65-85 wt %, based on the total weight of the adhesive mixture, and the ratio of [a4]:[b3] is from 0.7 to 0.9.
2. An adhesive made by mixing Part A and Part B of Embodiment 1 in a volumetric ratio of 0.8:1 to 1.2:1 to form an adhesive mixture, and the concentration of thermally conductive filler in the adhesive mixture is from 65-85 wt %, based on the total weight of the adhesive mixture, and the ratio of [a4]:[b3] is from 0.7 to 0.9.
3. A method for producing an adhesive, comprising the steps:
(1) providing a Part A resin component, comprising:
   (a1) at least one epoxy resin;
   (a2) at least one reactive flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9.
4. A method for adhering two substrates, the method comprising the steps:
(1) providing a Part A resin component, comprising:
   (a1) at least one epoxy resin;
   (a2) at least one reactive flexibilizer;
   (a3) at least one reactive silane;
   (a4) at least one thermally-conductive filler at a concentration of [a4] (wt %), based on the total weight of Part A;
(2) providing a Part B hardener component, comprising:
   (b1) at least one polyamine;
   (b2) at least one catalyst capable of catalyzing the reaction of an amine with an epoxy group;
   (b3) at least one thermally-conductive filler at a concentration of [b3] (wt %), based on the total weight of Part B;
(3) mixing Part A and Part B in a volumetric ratio of 0.8:1 to 1.2:1 to form an adhesive mixture to achieve concentration of thermally conductive filler in the adhesive mixture is from 65-85 wt %, based on the total weight of the adhesive mixture;
wherein the ratio of [a4]:[b3] is from 0.7 to 0.9;
(4) applying the adhesive mixture to at least one substrate;
(5) bringing a second substrate into adhesive contact with the adhesive mixture; and
(6) allowing the adhesive mixture to cure.
5. Embodiment 1, 2 or 3, wherein the reactive flexibilizer is a polyurethane-based flexibilizer.
6. Any one preceding embodiment, wherein the reactive silane comprises a hydrolysable silyl alkoxy group covalently bonded to a mercapto group, a primary or secondary amine group, or an epoxy group.
7. Any one preceding embodiment, wherein the reactive silane comprises a mercapto silane.
8. Embodiment 7, wherein the mercaptosilane is selected from mercaptoalkyl(trialkoxy)silanes and mercaptoalkyl(methyl-dialkoxy)silanes.
9. Embodiment 7, wherein the mercaptosilane is selected from gamma-mercaptopropyltrimethoxysilane, and gamma-mercaptopropyl(methyl-dimethoxy)silane.
10. Any one preceding embodiment, wherein the reactive silane comprises an aminosilane.
11. Embodiment 10, wherein the aminosilane is selected from aminoalkyl(trialkoxy)silanes and aminoalkyl(methyl-dialkoxy)silanes.
12. Embodiment 10, wherein the aminosilane is selected from bis-(trimethoxysilylpropyl)amine, (3-aminopropyl)trimethoxysilane, (3-aminopropyl)triethoxysilane, N-(2-aminoethyl)-3-aminopropyltrimethoxysilane, trimethoxysilylpropyldiethylenetriamine, with bis-(trimethoxysilylpropyl)amine.
13. Embodiment 10, wherein the aminosilane is (3-aminopropyl)trimethoxysilane.
14. Any one preceding embodiment, wherein the reactive silane comprises an epoxy silane.
15. Embodiment 14, wherein the epoxy silane is selected from glycidyloxyalkyl(trialkoxy)silanes and glycidyloxyalkyl(methyl-dialkoxy)silanes.
16. Embodiment 14, wherein the epoxy silane is selected from Tris(diethylene glycol methylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, and 2-(3,4-Epoxycyclohexyl)-ethyltriethoxysilane.
17. Embodiment 14, wherein the epoxy silane is Tris(diethyleneglycolmethylether) silyl propyleneglycidylether.
18. Any one preceding embodiment, wherein the volumetric ratio for mixing is 1:1.
19. Any one preceding embodiment, wherein the ratio of [a4]:[b3] is from 0.72 to 0.87.
20. Any one preceding embodiment, wherein the ratio of [a4]:[b3] is from 0.72 to 0.8.
21. Any one preceding embodiment, wherein the ratio of [a4]:[b3] is 0.75.
22. Any one preceding embodiment, wherein the epoxy equivalents per litre in Part A is from 1.50 to 4.50 mol/l
23. Any one preceding embodiment, wherein the epoxy equivalents per litre in Part A is from 2.50 to 3.50 mol/l.
24. Any one preceding embodiment, wherein the epoxy equivalents per litre in Part A is from 3.00 to 3.30 mmol/l.
25. Any one preceding embodiment, wherein the NH equivalents per litre of Component B is in the range of 1.50 to 4.50 mol/l.
26. Any one preceding embodiment, wherein the NH equivalents per litre of Component B is in the range of 2.50 to 3.75 mol/l.
27. Any one preceding embodiment, wherein the NH equivalents per litre of Component B is in the range of 3.00-3.40 mol/l.
28. Any one preceding embodiment, wherein the ratio of epoxy equivalents of Part A and the NH equivalents of Part B is within the range of 0.8:1 to 1.2:1.
29. Any one preceding embodiment, wherein the thermally conductive filler is used at a concentration of 50-80 wt %, based on the total weight of Part A.
30. Any one preceding embodiment, wherein the thermally conductive filler is used at a concentration of 55-65 wt % in Part (A), based on the total weight of Part A.
31. Any one preceding embodiment, wherein the thermally conductive filler is used at 70-90 wt % in Part (B), based on the total weight of Part (B).
32. Any one preceding embodiment, wherein the thermally conductive filler is used at 75 to 85 wt % in Part (B), based on the total weight of Part (B).
33. Any one preceding embodiment, wherein the thermally conductive filler is used at 55-65 wt % in Part (A), based on the total weight of Part A, and 75 to 85 wt % in Part (B), based on the total weight of Part (B).
34. Any one preceding embodiment, wherein the thermally conductive filler is aluminium trihydroxide.
35. Any one preceding embodiment, wherein the thermally conductive filler is ATH having a ratio D₉₀/D₅₀ of at or about 8 or more.
36. Any one preceding embodiment, wherein the at least one epoxy resin (a1) is based on bisphenol A, bisphenol F.
37. Any one preceding embodiment, wherein the at least one epoxy resin (a1) has general formula:

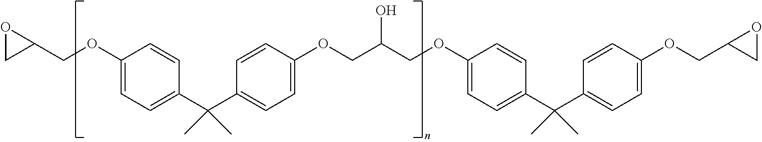

where n is in the range of 0 to about 25.
38. Any one preceding embodiment, wherein the at least one epoxy resin (a1) has an epoxy equivalent weight in the range of about 155 to 195 g/mol.
39. Any one preceding embodiment, wherein the at least one epoxy resin (a1) is a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 4000-14000 mPas (as measured according to ASTM D-445), for example, DER 331.
40. Any one preceding embodiment, wherein the at least one epoxy resin (a1) is a solid epoxy resin is a low molecular weight solid reaction product of epichlorohydrin and Bisphenol-A, having an epoxide equivalent weight of 475-550 g/eq (as measured according to ASTM D-1652), an epoxide percentage of 7.8-9.1% (as measured according to ASTM D-1652), an epoxide group content of 1820-2110 mmol/kg (as measured according to ASTM D-1652), and a melt viscosity at 150° C. of 400-950 mPas (as measured according to ASTM D-4287), for example, DER 671.
41. Any one preceding embodiment, wherein the at least one epoxy resin (a1) is present at 20 to 40 wt %, more preferably 25 to 35 wt %, particularly preferably at 25 to 30 wt %, based on the total weight of Part A of the adhesive.
42. Any one preceding embodiment, wherein the epoxy resin (a1) is Epoxy 1, used at 26 to 29 wt %, based on the total weight of Part A of the adhesive.
43. Any one preceding embodiment, wherein the reactive flexibilizer (a2) is made by reacting at least one polyol and optionally poly(butadiene) diol with a polyisocyanate in the presence of a polyurethane catalyst, optionally followed by chain extension with a di-phenol, and end-capping with a phenol, an oxime or a molecule of Formula I:

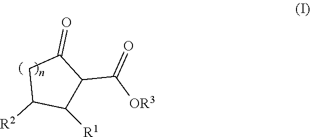

where R¹ and R² are independently selected from hydrogen and C₁ to C₆ alkyl, n is an integer from 1 to 2, and R³ is C₁ to C₆ alkyl.
44. Embodiment 43, wherein end-capping is carried out with a phenol.
45. Embodiment 43 or 44, wherein end-capping is carried out with O,O′-diallylbisphenol A or cardanol.
46. Any one of embodiments 43-45, wherein the at least one polyol is a poly(alkylene oxide) diol.
47. Embodiment 46, wherein the poly(alkylene oxide)diol is selected from poly(C₂-C₆ alkylene oxide) diols, particularly poly(tetramethylene oxide)diol (“PTMEG”), poly(trimethylene oxide)diol (“PO3G”), and mixtures of these.
48. Any one of embodiments 43-47, wherein the polyisocyanate is selected from toluene diisocyanate, 1,6-hexamethylenediisocyanate (“HMDI” or “HDI”), methylene diphenyl diisocyanate (“MDI”), 2,2,4-trimethylhexamethlyendiisocyanate (TMDI) and isophorone diisocyanate (IPDI).
49. Any one of embodiments 43-48, wherein the reactive flexibilizer (a2) comprises toluene diisocyanate as the polyisocyanate, poly(propylene oxide)diol or poly(tetramethylene oxide)diol (“PTMEG”) as the polyol [I believe this describes DESMODUR E15] and cardanol as the end-capping group.
50. Any one of embodiments 43-48, wherein the reactive flexibilizer (a2) comprises hexamethylene diisocyanate as the polyisocyanate, poly(tetramethylene oxide)diol as the polyol, and O,O′-diallylbisphenol A as chain extender and end-capping group.
51. Any one preceding embodiment, wherein the at least one polyamine (b1) has a primary and/or secondary amine functionality of 2 or 3 or greater.
52. Any one preceding embodiment, wherein the at least one polyamine (b1) is a polyetheramine.
53. Any one preceding embodiment, wherein the at least one polyamine (b1) is a di- or tri-amine having a molecular weight of 200-6,000 Da.
54. Any one preceding embodiment, wherein the at least one polyamine (b1) is a di- or tri-amine having a molecular weight of 1,000 to 2,000 Da.
55. Any one preceding embodiment, wherein the at least one polyamine (b1) is selected from:

| Trade name | Nature |
|---|---|
| Jeffamine T-403 | Polyetheramine characterized by repeating oxypropylene units in the backbone. JEFFAMINE T-403 is a trifunctional primary amine having an average molecular weight of approximately 440. Its amine groups are located on secondary carbon atoms at the ends of aliphatic polyether chains. 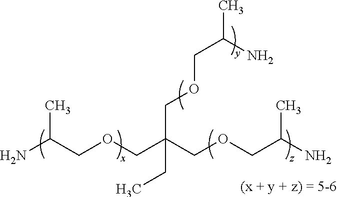 |
| Jeffamine D- 400 | Polyoxypropylenediamine: an Amine-terminated polyoxypropylene diol 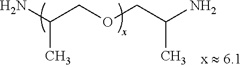 |
| Jeffamine D- 2000 | Polyetheramine characterized by repeating oxypropylene units in the backbone. JEFFAMINE D-2000 polyetheramine is a difunctional, primary amine with average molecular weight of about 2000. The primary amine groups are located on secondary carbon atoms at the end of the aliphatic polyether chains. 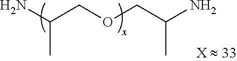 |
| TETA | Triethylenetetramine |
| Lupasol P | A branched aqueous solution of high molecular weight polyethylenimine homopolymer. 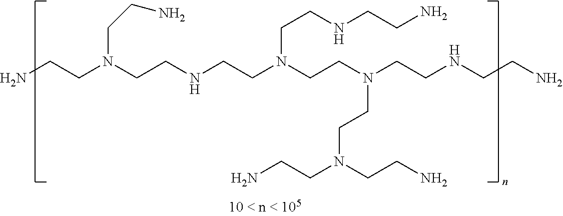 |
| 4,7,10- Trioxatridecane- 1,13-diamine | 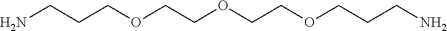 [SMILES: NCCCOCCOCCOCCCN] |
| | and, mixtures of any of the above. |

56. Any one preceding embodiment, wherein the at least one polyamine (b1) comprises a mixture of TETA and a difunctional, primary amine with average molecular weight of about 2000, of the following general structure:

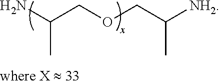

57. Any one preceding embodiment, wherein the NH equivalents per litre of Part B is in the range of 1.5 to 4.50 mol/l.
58. Any one preceding embodiment, wherein the NH equivalents per litre of Part B is in the range of 2.50 to 3.75 mol/l.
59. Any one preceding embodiment, wherein the NH equivalents per litre of Part B is in the range of 3.00 to 3.40 mol/l.
60. Any one preceding embodiment, wherein the catalyst (b2) is selected from ureas, tertiary amines and mixtures of these.
61. Any one preceding embodiment, wherein the catalyst (b2) is selected from p-chlorophenyl-N,N-dimethylurea (Monuron), 3-phenyl-1,1 dimethylurea (Phenuron), 3,4-dichlorophenylN, N-dimethylurea (Diuron), N-(3 chloro-4-methylphenyl)-N′,N′-dimethylurea 25 (Chlortoluron), tert-acryl- or alkylene amines like benzyldimethylamine, 2,4,6-tris(dimethylaminomethyl) phenol, piperidine or derivatives thereof, various aliphatic urea compounds such as are described in EP1916272; C₁-C₁₂ alkylene imidazole or N-arylimidazoles, such as 2-ethyl-2-methylimidazol, or N-butylimidazole and 6-caprolactam, 2,4,6-tris(dimethylaminomethyl) phenol, particularly integrated into a poly(p-vinylphenol) matrix (as described in European patent EP0197892), or 2,4,6-tris(dimethylaminomethyl) phenol integrated into a novolac resin, including those described in U.S. Pat. No. 4,701,378.
62. Any one preceding embodiment, wherein the catalyst (b2) is tris-2,4,6-tris(dimethylaminomethyl) phenol.
63. Any one preceding embodiment, wherein the catalyst (b2) is used at 1 to 6 wt %, based on the total weight of Component B.
64. Any one preceding embodiment, wherein the catalyst (b2) is used at 2 to 5 wt %, based on the total weight of Component B.
65. Any one preceding embodiment, wherein the catalyst (b2) is used at 3 or 4 wt %, based on the total weight of Component B.

### Examples

TABLE 1
List of ingredients used in tougheners and adhesives of the Examples

| Ingredient | Chemistry |
|---|---|
| PolyTHF 2000 | Polytetrahydrofuran-Diol 2000 g/mol |
| PolyVest HT | Hydroxylated Polybutadiene 2800 g/mol |
| 1.6 HDI (Desmodur H) | 1.6-hexamethylenediisocyanate |
| TIB KAT 718 | Blend of bismuth and zinc carboxylates |
| DBTL (DABCO T12) | Dibutyltin dilaureate |
| D.E.R. 331 | a liquid reaction product of epichlorohydrin and bisphenol A, |
| | having an epoxide equivalent weight of 182-192 g/eq (as |
| | measured according to ASTM D-1652), an epoxide percentage of |
| | 22.4-23.6% (as measured according to ASTM D-1652), an |
| | epoxide group content of 5200-5500 mmol/kg (as measured |
| | according to ASTM D-1652), and a viscosity at 25° C. of 11,000- |
| | 14,000 mPas (as measured according to ASTM D-445) |
| D.E.R. 732 | A reaction product of epichlorohydrin and polypropylene glycol, |
| | having an epoxide equivalent weight of 310-330 g/eq (as |
| | measured according to ASTM D-1652), an epoxide percentage of |
| | 13-13.9% (as measured according to ASTM D-1652), an epoxide |
| | group content of 3030-3230 mmol/kg (as measured according to |
| | ASTM D-1652), and a viscosity at 25° C. of 60-70 mPas (as |
| | measured according to ASTM D-445) |
| RAM 1087 | Tris(diethylene glycol methylether) silyl propyleneglycidylether 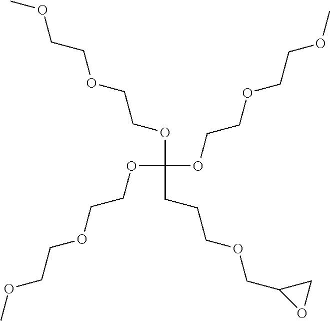 |
| Dynasilan 1189 | N-(n-Butyl)-3-aminopropyltrimethoxysilane |
| Araldit DW 0135 blau | Blue dye in bisphenol A-based epoxy resin (masterbatch) |
| Cardolite NX2026 | Cardanol |
| Jeffamin D-2000 | polyetheramine characterized by repeating oxypropylene units in the backbone. As shown by the representative structure, JEFFAMINE D-2000 polyetheramine is a difunctional, primary amine with average molecular weight of about 2000. The primary amine groups are located on secondary carbon atoms at the end of the aliphatic polyether chains. 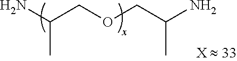 |
| Ancamine K 54 | tris-2,4,6-dimethylaminomethyl phenol 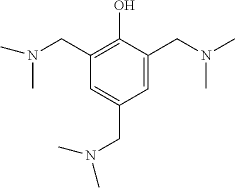 |
| RAM 965 | PU-toughener (flexibilizer) derived from hexamethylene |
| | diisocyanate, poly(tetramethylene oxide)glycol-chain |
| | extended and capped with O,O′-diallylbisphenol A. |
| | Described as “Flexibilizer DY 965” in WO2016108958A1, |
| | incorporated herein by reference |
| TETA | Triethylenetetramine |
| GF 200 | Blocked polyurethane polymer toughener (flexibilizer, see |
| | description below) |
| DESMODUR E15 | Aromatic polyisocyanate prepolymer based on toluene |
| | diisocyanate |
| DABCO T12N | Dibutyl tin dilaurate |
| Aerosil 208 | Fumed silica after-treated with polydimethylsiloxane |
| Apyral 20X | Bimodally distributed aluminium trihydroxide (ATH) |
| | Particle size (by laser diffraction in acetone): |
| | D₁₀ (micron) 0.5 |
| | D₅₀ (micron) 8 |
| | D₉₀ (micron) 80 |

D.E.R.™ 331™ Liquid Epoxy Resin is a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5200-5500 mmol/kg (as measured according to ASTM D-1652), and a viscosity at 25° C. of 11000-14000 mPas (as measured according to ASTM D-445).

### Production of Toughener GF200

GF200 was produced from the ingredients in Table 2.

GF200 is the reaction product of Desmodur E15 and Cardolite NX-2026. Reaction procedure: Cardolite NX-2026 and Desmodur E15 are heated in a reactor to 60° C. DABCO T-12N (catalyst) is then added. The reaction mixture is stirred for 45 min at 80° C. under an atmosphere of nitrogen and then for 10 min under vacuum. The colourless reaction product is then cooled to RT and transferred into a container.

TABLE 2
Ingredients in GF200

| Ingredient | Amount |
|---|---|
| Cardolite NX-2026 (wt %) | 22.1 |
| Desmodur E15 (wt %) | 77.85 |
| DABCO T-12N (wt %) | 0.05 |
| Results - Properties | |
| Viscosity (23° C., CP4/20, up/down | 45 |
| Newtonian) (Pa · s) | |
| NCO (%) | <0.8 |
| GPC MW | 3500 |
| GPC PDI | 1.1 |

### Formulation of Epoxy Adhesives

The components of Component-A (epoxy resin component) for the comparative and inventive examples are shown in Table 3. The ingredients are compounded by mixing the ingredients listed in Table 3 on a planetary mixer or on a dual asymmetric centrifuge. In a first phase the liquid phases were mixed before the solid material is added to the formulation. The formulation was mixed for ca 30 min under vacuum before being filled into cartridges, pails, or drums.

The components of Component-B (amine or hardener component) for the comparative and inventive examples are shown in Table 4. The ingredients are compounded by mixing the ingredients listed in Table 4 on a planetary mixer or on a dual asymmetric centrifuge. In a first phase the liquid phases were mixed before the solid material is added to the formulation. The formulation was mixed for ca 30 min under vacuum before being filled into cartridges, pails, or drums.

TABLE 3
Component-A (epoxy resin component) for
comparative and inventive Examples

| | Comp. | Comp. | Inv. | Inv. |
|---|---|---|---|---|
| Ingredient | Resin 1 | Resin 2 | Resin 3 | Resin 4 |
| D.E.R. 331 | 17.40 | 18.40 | 28.4 | 28.4 |
| RAM 965 | 5.00 | — | 5.00 | — |
| GF 200 | — | 5.00 | — | 5.00 |
| RAM 1087 (epoxy | 1.20 | 1.20 | 1.20 | 1.20 |
| silane) | | | | |
| DER 732 | 4.00 | 4.00 | 4.00 | 4.00 |
| ARALDITE DW 0135 | 0.40 | 0.40 | 0.40 | 0.40 |
| BLUE | | | | |
| Aerosil R208 | 1.00 | 1.00 | 1.00 | 1.00 |
| Apyral 20X | 70.00 | 70.00 | 60.00 | 60.00 |
| Est. epoxy equivalents | 2.47 | 2.60 | 3.17 | 3.29 |
| per liter [mol/L] | | | | |
| Yield stress 23° C. [Pa] | 256 | 137 | 47 | 37 |
| Plastic Viscosity 23° C. | 270 | 85 | 135 | 54 |
| [Pas] | | | | |

TABLE 4
Component-B (amine hardener component)
for comparative and inventive Examples

| | Comparative amine | Inventive amine |
|---|---|---|
| Ingredient | hardener 1 (wt %) | hardener 2 (wt %) |
| TETA | 2.6 | 3.7 |
| Dynasilan 1189 | 1.5 | 1.5 |
| Jeffamine D2000 | 17.9 | 6.8 |
| Ancamine K54 | 4.0 | 4.0 |
| RAM 965 | 3.0 | 3.0 |
| Aerosil 208 | 1.0 | 1.0 |
| Apyral 20X | 70.0 | 80.0 |
| Est. NH equivalents per litre | 2.61 | 3.30 |
| (mol/l) | | |
| Yield stress 23° C. (Pa) | 148 | 468 |
| Plastic viscosity 23° C. (Pas) | 13 | 26 |

The epoxy resin components are summarized in Table 3. Comparative resins 1 and 2 contain 70 wt % of thermally conductive filler and only around 18% of epoxy resin. Inventive resins 3 and 4 contain only 60 wt % of thermally conductive filler.

Comparative resin 1 and Inventive resin 3 use the same toughener (RAM 965), while Comparative resin 2 and Inventive resin 4 use the same toughener (GF 200).

Table 4 shows the amine hardener component used for curing of the different adhesives. Comparative amine hardener 1 is designed for a 1:1 mixing ratio using evenly distributed thermally conductive filler levels in resin component and hardener component. The filler level is at 70 wt % thermally conductive filler. It was used for mixing with Comparative resin 1 and Comparative resin 2.

Inventive amine hardener 2 is designed for a 1:1 mixing ratio with a higher filler content than its corresponding resin components, at 80 wt % of thermally conductive filler. It was used for mixing with the inventive resins 3 and 4.

The amine functionality of the two amine hardener components is adjusted to match the epoxy functionality in the epoxy resin component.

### Test Methods

### Rheology

Viscosity was measured using a Bohlin Rheometer, C/P 20, up/down 0.1-20 s-1; evaluation according to Casson model.

### Lap Shear Strength

Lap shear strength was measured according to DIN EN 1465:2009:
on DX 56 Z, thickness 0.7 mm or described substrate as shown in the table; degreased with Heptanes, 10×25 mm bonded area, 0.2 mm adhesive layer thickness. The Failure mode after lap shear testing is analyzed and categorized by cohesive failure (CF) and adhesive failure (AF). Values are rounded to multiples of 10%.

### Tensile Testing

A plate of the cured adhesive was prepared in a thickness of 2 mm and cured at room temperature for 7 d. Dog bone shaped specimens were cut out of the plate. The dimensions were according to DIN ISO EN-527-1 and the test was performed accordingly an a zwick tensile tester.

### T-Peel Strength

T-peel strength was measured according to ISO 11339:2010. The samples were DC 04 ZE (steel) from Thyssen Krupp in 0.7 mm thickness. Glass beads with a thickness of 0.2 mm were used as spacers between both strips to adjust the adhesive layer to 0.2 mm. Metal clips were used to hold the two strips together during curing cycle for 7 d at room temperature. The test was performed according ISO 11339.

### Thermal Conductivity

Thermal conductivity was measured according to ASTM 5470-12 on a thermal interface material tester from ZFW Stuttgart. The tests were performed in Spaltplus mode at a thickness of 1.0 mm. The described thermal interface material was considered as Type I (viscous liquids) as described in ASTM 5470-12. The upper contact was heated to ca 40° C. and the lower contact to ca 10° C., resulting in a sample temperature of ca 25° C. The A and B component were mixed with a static mixer when applied from a manual cartridge system to prepare a plaque with a thickness of 1.0 mm to measure thermal conductivity after cure.

### Volume Resistivity

Volume resistivity was measured according to ASTM D257, IEC 62631-3-1, using 500 V applied for 60 seconds.

### Results

The results of testing are summarised in Table 5. Comparative Examples are designated “CE” and Inventive Examples are designated “IE”.

TABLE 5
Results of testing of Comparative and Inventive Examples

| | | CE1 | CE2 | IE3 | IE4 |
|---|---|---|---|---|---|
| | | Epoxy resin formulation | | | |
| | | Comp. | Comp. | Inv. | Inv. |
| | | Resin 1 | Resin 2 | Resin 3 | Resin 4 |
| | | Hardener | | | |
| | | Comp. | Comp. | Inv. | Inv. |
| | | Hardener 1 | Hardener 1 | Hardener 2 | Hardener 2 |
| | | Mixing ratio | | | |
| | | 1:1 | 1:1 | 1:1 | 1:1 |
| Mechanical | E-modulus [MPa] | 1048 | 1292 | 4905 | 5970 |
| properties | Tensile strength [MPa] | 10.5 | 13.4 | 21.5 | 23.8 |
| | Elongation at break [%] | 4 | 4 | 0.5 | 0.5 |
| | Lap Shear Strength | 12.6 | 13.2 | 12.8 | 13.0 |
| | DX 56 Z 0.7 mm [MPa] | | | | |
| | T-peel strength at 23° C. | 1.54 | 1.07 | 1.27 | 1.18 |
| | DX 56 Z 0.7 mm [N/mm] | | | | |
| | T-peel failure mode at 23° C. | 100% AF | 20% CF/ | 100% CF | 100% CF |
| | DX 56 Z 0.7 mm | | 80% AF | | |
| Elect. | Thermal conductivity [W/mK] | 1.1 | 1.1 | 1.1 | 1.1 |
| properties | Volume resistivity [Ω-m] | 10(13) | 10(13) | 10(14) | 10(14) |

The Inventive Example 3 shows a significant improvement of the T-peel failure mode of the adhesive over Comparative Example 1 with 100% cohesive vs. 100% adhesive failure mode. The same is true for Inventive Example 4 compared to the Comparative Example 2 with 100% cohesive vs. 80% adhesive failure mode, respectively.

In addition, the volume resistivity of the Inventive Examples is superior by one magnitude over the Comparative Examples, indicating significantly better electrical properties with the inventive approach.

1. A two-component, thermally conductive adhesive comprising:
(A) a Part A resin component, comprising:
(a1) at least one epoxy resin;
(a2) at least one reactive flexibilizer;
(a3) at least one reactive silane;
(a4) at least one thermally-conductive filler at a concentration of [a4] (wt %), based on the total weight of Part A;
and
(B) a Part B hardener component, comprising:
(b1) at least one polyamine;
(b2) at least one catalyst capable of catalyzing the reaction of an amine with an epoxy group;
(b3) at least one thermally-conductive filler at a concentration of [b3] (wt %), based on the total weight of Part B;
wherein, in use, Part A and Part B are mixed together in a volumetric ratio of 0.8:1 to 1.2:1 to form an adhesive mixture, and the concentration of thermally conductive filler in the adhesive mixture is from 65-85 wt %, based on the total weight of the adhesive mixture, and the ratio of [a4]:[b3] is from 0.7 to 0.9.

2. The adhesive of claim 1, wherein the reactive flexibilizer is a polyurethane-based flexibilizer.

3. The adhesive of claim 1, wherein the reactive silane comprises a hydrolysable silyl alkoxy group covalently bonded to a mercapto group, a primary or secondary amine group, or an epoxy group.

4. The adhesive of claim 1, wherein the reactive silane comprises a mercapto silane.

5. The adhesive of claim 4, wherein the mercaptosilane is selected from mercaptoalkyl(trialkoxy)silanes and mercaptoalkyl(methyl-dialkoxy)silanes.

6. The adhesive of claim 4, wherein the mercaptosilane is selected from gamma-mercaptopropyltrimethoxysilane, and gamma-mercaptopropyl(methyl-dimethoxy)silane.

7. The adhesive of claim 1, wherein the reactive silane comprises an aminosilane.

8. The adhesive of claim 7, wherein the aminosilane is selected from aminoalkyl(trialkoxy)silanes and aminoalkyl(methyl-dialkoxy)silanes.

9. The adhesive of claim 8, wherein the aminosilane is selected from bis-(trimethoxysilylpropyl)amine, (3-aminopropyl)trimethoxysilane, (3-aminopropyl)triethoxysilane, N-(2-aminoethyl)-3-aminopropyltrimethoxysilane, trimethoxysilylpropyldiethylenetriamine, with bis-(trimethoxysilylpropyl)amine.

10. The adhesive of claim 9, wherein the aminosilane is (3-aminopropyl)trimethoxysilane.

11. The adhesive of claim 1, wherein the reactive silane comprises an epoxy silane.

12. The adhesive of claim 11, wherein the epoxy silane is selected from glycidyloxyalkyl(trialkoxy)silanes and glycidyloxyalkyl(methyl-dialkoxy)silanes.

13. The adhesive of claim 12, wherein the epoxy silane is selected from Tris(diethyleneglycolmethylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, and 2-(3,4-Epoxycyclohexyl)-ethyltriethoxysilane.

14. The adhesive of claim 13, wherein the epoxy silane is Tris(diethylene glycol methylether) silyl propyleneglycidylether.

15. The adhesive of claim 1, wherein the volumetric ratio for mixing is 1:1.
